(19) United States
(12) Patent Application Publication
(10) Pub. No.: US 2024/0114247 A1
(43) Pub. Date: Apr. 4, 2024

(54) REMOTELY-OPERABLE TRAIL CAMERA WITH ZOOM, PAN & TILT

(71) Applicant: Mark Radtke, Darien, WI (US)

(72) Inventor: Mark Radtke, Darien, WI (US)

(21) Appl. No.: 17/958,360

(22) Filed: Oct. 1, 2022

(51) Int. Cl. H04N 23/695; H04N 23/23; H04N 23/55; H04N 23/65; H04N 23/661; H04N 23/69

(52) U.S. Cl. CPC H04N 23/695; H04N 23/23; H04N 23/55; H04N 23/65; H04N 23/662; H04N 23/69

(57) ABSTRACT

A remotely-operable portable trail camera includes a processing unit, an image sensor, a zoom lens, and a zoom level detecting and adjusting circuit. A panhead permits the image sensor to be adjusted azimuthally in a left-right direction and elevationally in an upward-downward direction. A panning control circuit controls a motion of the panhead azimuthally in the left-right direction. A tilting control circuit controls a motion of the panhead elevationally in the upward-downward direction. An object detection circuit detects a motion of a target object. In response to the detection of the motion, the processing unit controls the panning control circuit, the tilting control circuit, and the zoom level detecting and adjusting circuit so as to aim the image sensor towards the target object. The panning control circuit, the tilting control circuit, and the zoom level detecting and adjusting circuit are operatively coupled to a cellular transceiver and can be controlled over a cellphone network using an application on a smartphone or other mobile device.

### CROSS REFERENCE TO RELATED APPLICATIONS

The present application claims the benefit of the filing date of U.S. Provisional Patent Application Serial Number 63/xxx,xxx, filed on xxxxx, xx, 2021, the disclosure of which is incorporated herein by reference in its entirety.

### BACKGROUND

The present invention relates to portable, self-contained trail cameras that can be used outdoors. Existing trail cameras provide a fixed, stationary field of view configured for photographing target objects that pass directly in front of the camera. The fixed field of view may omit portions of target objects that are too close to the camera, and/or target objects that are large. Likewise, the fixed field of view may produce poor, grainy images of target objects that are small, and/or far away from the camera. Moreover, existing trail cameras are not able to track the target object as the object moves.

Trail cameras are typically used by hunters who are hunting for game, biologists who are studying wildlife, and/or property owners who wish to prevent theft. While hunting for game, a typical hunt may involve a team of several hunters. When several hunters are present, the need for a hunter to communicate with other hunters on the team is essential so that all hunters are aware of the whereabouts of each hunter in the team. Even though mobile phones can be used to communicate effectively across open, flat terrain, the use of mobile phones is limited in rural areas and also in areas with hilly terrain. In many cases, cellular networks are unavailable or unreliable in areas where hunting is a popular activity. Finding directions for navigating through rugged or unfamiliar terrain can also be difficult when cellular networks are unavailable or provide intermittent coverage. What is needed is an improved mobile field camera that overcomes these and other shortcomings.

### SUMMARY

One example embodiment comprises a portable trail camera. The portable trail camera includes an image sensor; a zoom lens, operatively coupled to the image sensor, for applying a zoom level to one or more images captured by the image sensor; a zoom level detecting and adjusting circuit, operatively coupled to the zoom lens, for detecting and adjusting the applied zoom level; a panhead, operatively coupled to the image sensor, that permits the image sensor to be adjusted azimuthally in a left-right direction, and adjusted elevationally in an upward-downward direction; a panning control circuit, operatively coupled to the panhead, for controlling a motion of the panhead azimuthally in the left-right direction; a tilting control circuit, operatively coupled to the panhead, for controlling a motion of the panhead elevationally in the upward-downward direction; an object detection circuit, operatively coupled to the image sensor, for detecting a motion of a target object; a processing unit, operatively coupled to the image sensor, the zoom level detecting and adjusting circuit, the panning control circuit, the tilting control circuit, and the object detection circuit; and a memory storage device operatively coupled to the processing unit; wherein, in response to the object detection circuit detecting the motion of the target object, the processing unit controls the panning control circuit and the tilting control circuit to aim the image sensor towards the target object; wherein, in response to controlling the panning control circuit and the tilting control circuit, the processing unit controls the zoom level detecting and adjusting circuit to automatically focus the image sensor on the target object; wherein the image sensor captures one or more images of the target object; and wherein the processing unit stores the one or more captured images in the memory storage device. The zoom level detecting and adjusting circuit, the panning control circuit, and the tilting control circuit are operatively coupled to a wireless receiver circuit. The wireless receiver circuit is operatively coupled to one or more antennas. Adjusting one or more of the zoom level detecting and adjusting circuit, the panning control circuit, or the tilting control circuit, is performed in response to receiving at least one signal at the wireless receiver circuit. In some embodiments, the wireless receiver circuit is a cellular transceiver configured for communicating over a cellular network. The adjusting is performed remotely from the portable trail camera, wherein the cellular transceiver communicates with a smartphone or other mobile device over the cellular network. The smartphone or other mobile device is configured with an application for controlling the portable trail camera.

In some embodiments, the portable trail camera further comprises a notification mechanism, operatively coupled to the processing unit, wherein the notification mechanism is configured to provide a visual notification and/or a visual alert to a user in response to one or more of: the object detection circuit detecting the motion of the target object; the image sensor capturing one or more images of the target object; and/or the processing unit storing the one or more captured images in the memory storage device. In some embodiments, the notification mechanism is provided using the cellular transceiver and the application for controlling the portable camera.

In some embodiments, the portable trail camera further comprises a speaker configured to provide an audible notification and/or an audible alert to a user in response to one or more of: the object detection circuit detecting the motion of the target object; the image sensor capturing one or more images of the target object; and/or the processing unit storing the one or more captured images in the memory storage device.

In some embodiments, the portable trail camera further comprises one or more of a cellular transceiver or a satellite transceiver, operatively coupled to the processing unit, for uploading the one or more captured images from the memory storage device and transmitting the one or more captured images over a wireless communications link.

In some embodiments, the portable trail camera further comprises a multiple input, multiple output (MIMO) antenna array operatively coupled to the cellular transceiver.

In some embodiments, the portable trail camera further comprises a radio frequency transceiver operatively coupled to a microphone and a speaker, the radio frequency transceiver configured for performing two-way communication over a radio frequency communications link.

In some embodiments, the portable trail camera further comprises a multiple input, multiple output (MIMO) antenna array operatively coupled to the radio frequency transceiver.

In some embodiments, the image sensor further comprises an infrared night vision sensor configured for viewing the target object under low-light conditions.

In some embodiments, the portable trail camera further comprises a solar cell operatively coupled to a backup battery, wherein the solar cell powers the portable trail camera when the solar cell is illuminated, wherein the backup battery powers the portable trail camera when the solar cell is not illuminated, and wherein the solar cell charges the backup battery when the solar cell is illuminated.

In some embodiments, the portable trail camera further comprises a main body and a secondary camera, wherein the image sensor is positioned opposite the secondary camera across the main body, and wherein the secondary camera is operatively coupled to the processing unit.

In some embodiments, the portable trail camera further comprises a global positioning system (GPS) device, operatively coupled to the processing unit, wherein the one or more images of the target object are associated with a geographic location obtained by the GPS device, and the one or more images are stored with the geographic location in the memory storage device

### BRIEF DESCRIPTION OF THE DRAWINGS

FIG. 1 is a perspective view of the trail camera.

FIG. 2 is an exploded view of the trail camera.

FIG. 3 is an exploded view of the rear assembly of the trail camera.

FIG. 4 is an exploded view of the interior of the trail camera.

FIG. 5 is an exploded view of the camera holder.

FIG. 6 is a perspective view of the solar panel housing.

FIG. 7 is a perspective view of the mounting plate.

FIG. 8 is a perspective view of the camera holder.

FIG. 9 is a perspective view of the camera housing.

FIG. 10 is a perspective view of the assembled camera system.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, computer readable storage medium and/or system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer readable medium or a non-transitory computer readable storage medium.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one example. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow.

Data shared and received may be stored in a database, which maintains data in one single database (e.g., database server) and generally at one particular location. This location is often a central computer, for example, a desktop central processing unit (CPU), a server CPU, or a mainframe computer. Information stored on a centralized database is typically accessible from multiple different points. A centralized database is easy to manage, maintain, and control, especially for purposes of security because of its single location. Within a centralized database, data redundancy is minimized as a single storing place of all data also implies that a given set of data only has one primary record. A blockchain may be used for storing transport-related data and transactions.

Any of the actions described herein may be performed by one or more processors (such as a microprocessor, a sensor, an Electronic Control Unit (ECU), a head unit, or the like). The one or more processors may communicate with other processors. The one or more processors and the other processors can send data, receive data, and utilize this data to perform one or more of the actions described or depicted herein.

In some embodiments, the trail camera of the present invention can be used by hunters and/or biologists to obtain pictures of wildlife. Likewise, in some embodiments, property owners can utilize the trail camera of the present invention to photograph potential thieves. According to a further embodiment, the trail camera allows the user to record still images and/or motion video of a target object on a computer-readable storage medium for future reference. In a further embodiment, the computer-readable storage medium can be a portable, removable memory card such as a USB thumb drive, a portable hard drive, a secure digital extended capacity (SDXC) card, another type of memory card, or any of various combinations thereof.

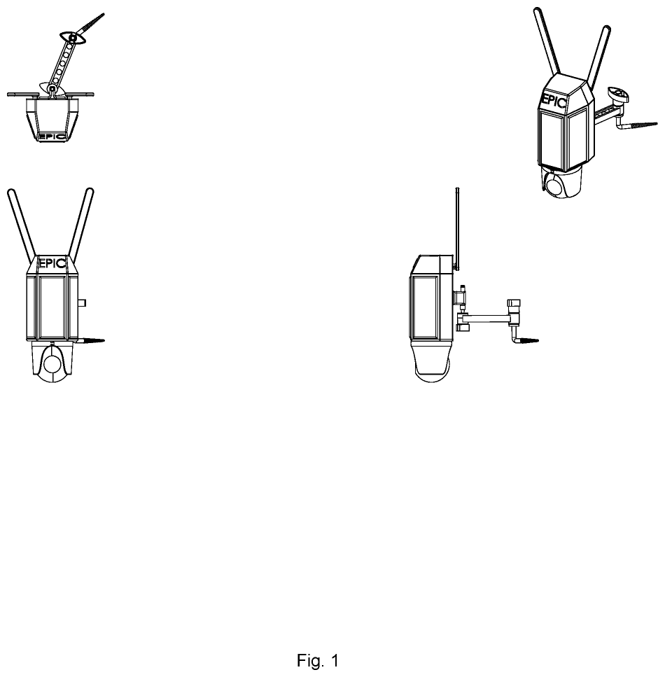

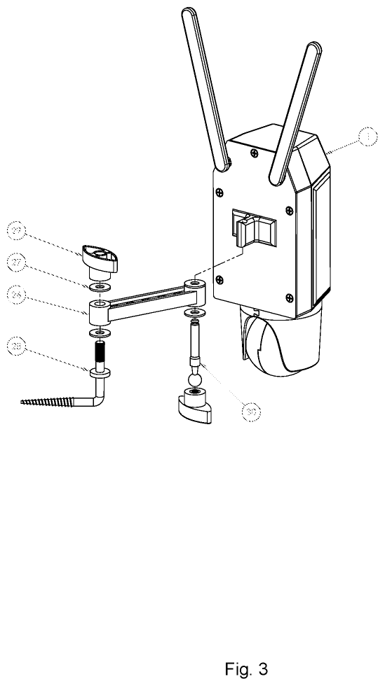

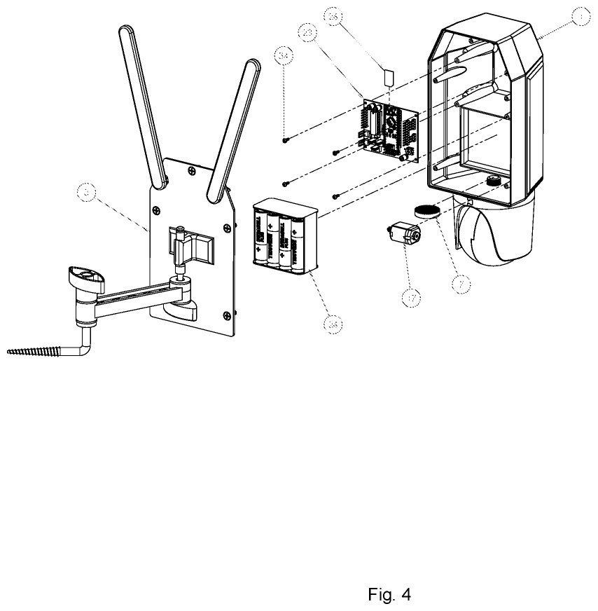

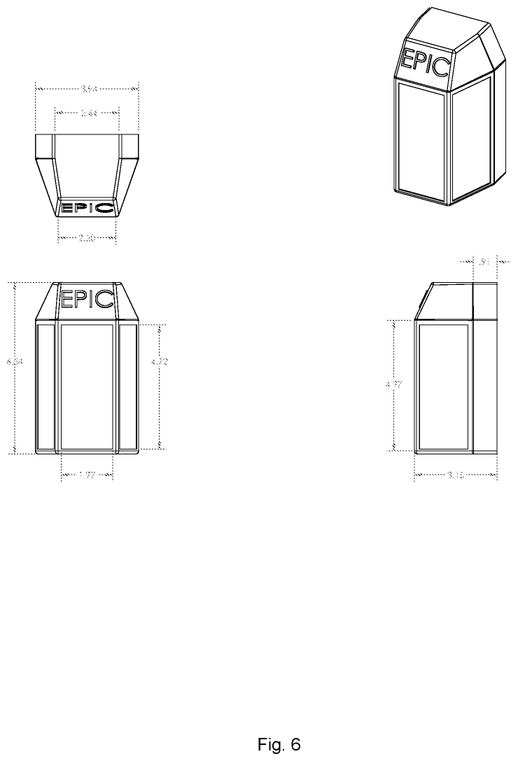

As seen in FIGS. 1-6, in some embodiments, the present solution comprises a primary camera 1, an optional secondary camera 2, a processing unit 4, a control unit 5, a memory storage device 8, and a main body 22. In some embodiments, in order to maintain a compact structure, the primary camera 1 and the optional secondary camera 2 are mounted into the main body 22. The main body 22 can be designed from durable yet lightweight material.

The primary camera 1 is configured for receiving and capturing one or more still images, and/or configured for receiving and capturing full-motion video. Likewise, the optional secondary camera 2 is configured for receiving and capturing one or more still images, and/or configured for receiving and capturing full-motion video. The one or more still images and/or full-motion video are received from the primary camera 1 and/or the optional secondary camera 2 by the processing unit 4 and electronically stored in the memory storage device 8. The primary camera 1 and the optional secondary camera 2 can each vary in size, quality, and shape, in accordance with different embodiments of the present solution. In some embodiments, the main body 22 includes a bracket or other mechanism for mounting to a stationary object such as a tree, a tripod, a fence, or a pole.

In some embodiments, the primary camera 1 is used for receiving and capturing one or more still images and/or a full-motion video of the target object and the vicinity of the target object. The optional secondary camera 2 can be used to record a user of the trail camera, such as a hunter or a biologist, for example. In embodiments where the secondary camera 2 is provided, the primary camera 1 can be positioned opposite the secondary camera 2 across the main body 22. The user and the target can be simultaneously recorded as a result of the relative positioning of the primary camera 1 to the secondary camera 2. More specifically, the primary camera 1 and the secondary camera 2 are oriented in opposing directions allowing simultaneous image and/or video recording of the target object and the user.

The processing unit 4 manages captured still image data and captured video data received by the primary camera 1 and/or the optional secondary camera 2. The processing unit 4 also manages control data for controlling the trail camera. In order to do so, the primary camera 1, the optional secondary camera 2, the control unit 5, and the memory storage device 8 are electronically connected to the processing unit 4. The control unit 5 allows the user to control the trail camera. In order to do so, the control unit 5 comprises a plurality of controls 6 which are integrated into the main body 22. As an example, if the user intends on managing the primary camera 1 (and/or the optional secondary camera 2), the control unit 5 can be used since the control unit 5 is electronically connected to the processing unit 4.

When image data and/or video data is captured by the primary camera 1, the image data and/or video data is transferred to the memory storage device 8 through the processing unit 4, allowing the user to extract the image data and/or the video data whenever the need arises using the control unit 5. Likewise, when image data and/or video data is captured by the optional secondary camera 2, the image data and/or video data is transferred to the memory storage device 8 through the processing unit 4, allowing the user to extract the image data and/or the video data whenever the need arises using the control unit 5. Both the processing unit 4 and the memory storage device 8 are enclosed within the main body 22. The positioning of the processing unit 4 and the memory storage device 8 allows the overall compact structure of the trail camera to be maintained while also protecting the components from external impacts.

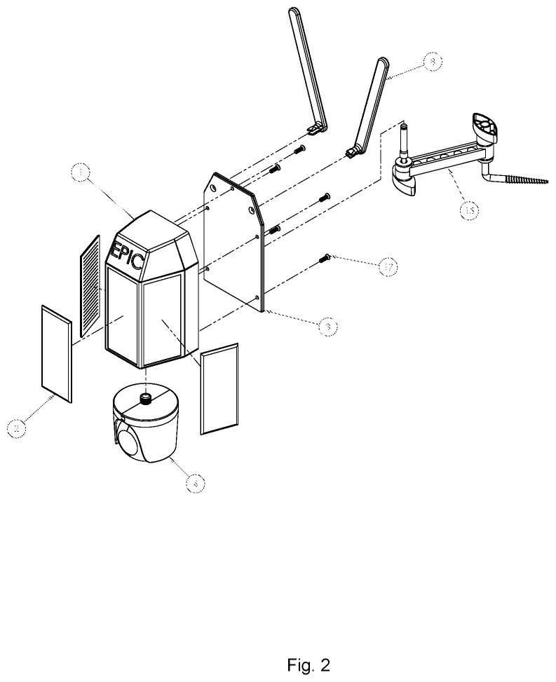

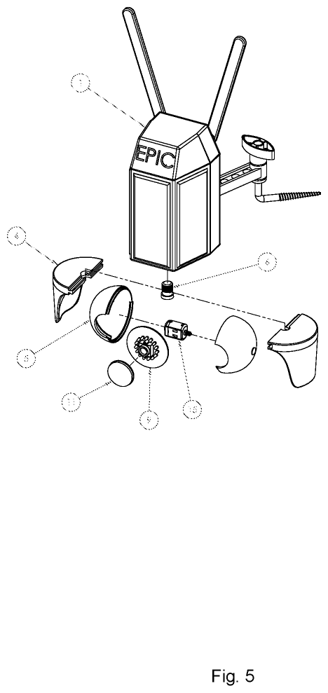

In some embodiments, the trail camera can be used outdoors. As seen in FIG. 2 and FIG. 5, the present invention comprises a waterproof housing 7 to protect the remainder of the components from hazardous environmental conditions. When the waterproof housing 7 is being used, the main body 22, the primary camera 1, the optional secondary camera 2, and the display screen 3 are positioned within the waterproof housing 7. In some embodiments, the waterproof housing 7 is made of a transparent material such that the functions of the primary camera 1 and the secondary camera 2 are not hindered.

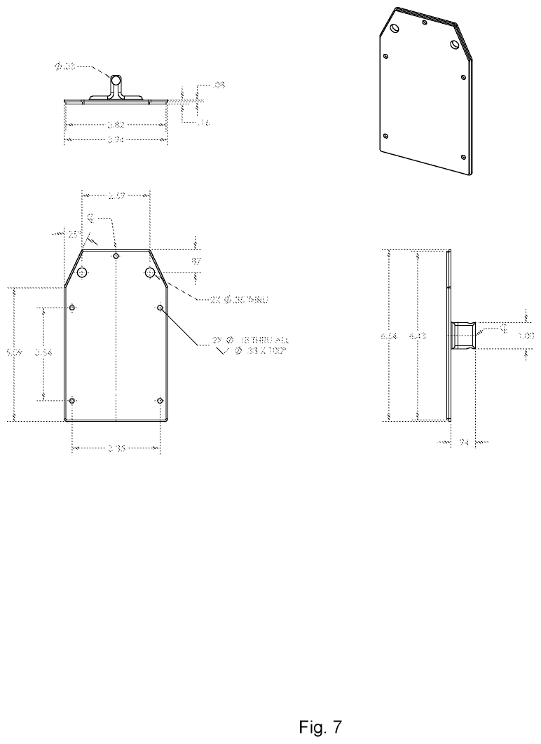

As experienced by many biologists and hunters, being aware of slight movements can be crucial when observing or hunting wildlife. In order to notify the user regarding the slightest movements of the target object, in some embodiments, the trail camera comprises a motion detector unit 9 as seen in FIG. 7. The motion detector is electronically connected to the processing unit 4 and is positioned into the main body 22. Since any movement of the target object in front of the user should be observed, the motion detector unit 9 can be positioned adjacent the primary camera 1. Therefore, the motion detector unit 9 detects any movement of the target object in front of the user. When the motion detector unit 9 is triggered with a movement, the user is notified using the processing unit 4. Even though one motion detector unit 9 is used in some embodiments, multiple motion detector units can be used in other embodiments. As a result, the user can be notified regarding movement across a wide range of distances.

In some embodiments, in response to the motion detector unit 9 detecting motion, the processing unit 4 triggers the primary camera 1 to commence recording one or more still images. Likewise, in some embodiments, in response to the motion detector unit 9 detecting motion, the processing unit 4 triggers the primary camera 1 to commence recording a full-motion video. The recording of the one or more still images and/or full-motion video may continue for a first predetermined period of time subsequent to the motion detector unit 9 detecting motion. The recording may cease upon expiration of a predetermined period of time with no motion being detected by the motion detector unit 9.

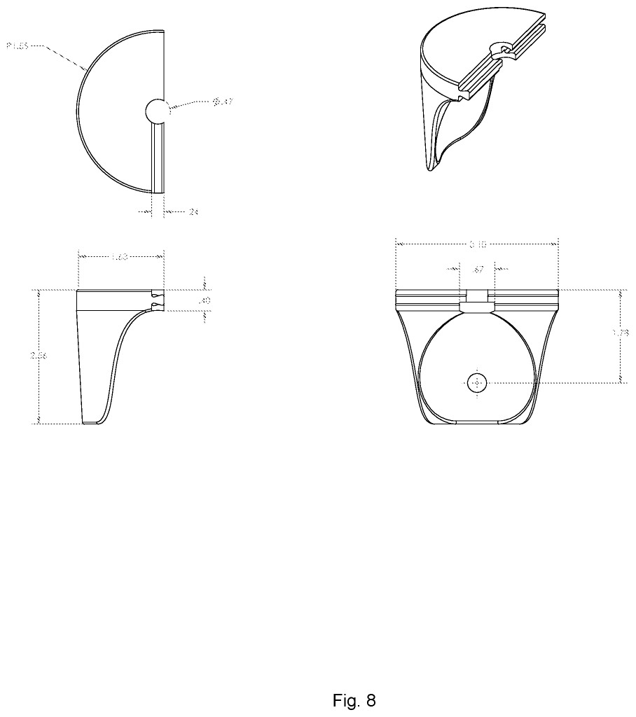

Limited visibility during low-light conditions can be both disadvantageous and dangerous to the user of the trail camera. As seen in FIG. 8, in some embodiments, the trail camera comprises a night vision unit 12 which can be integrated into the primary camera 1, and/or the optional secondary camera 2. Therefore, the primary camera 1 and/or the optional secondary camera 2, can continue to capture data even in low light conditions. Moreover, the night vision unit 12 is also communicably coupled to the display screen 3. Therefore, the display screen 3 can display data received from the primary camera 1 with added brightness. The night vision unit 12 is electronically connected to the processing unit 4, allowing the user to control the night vision unit 12 as preferred.

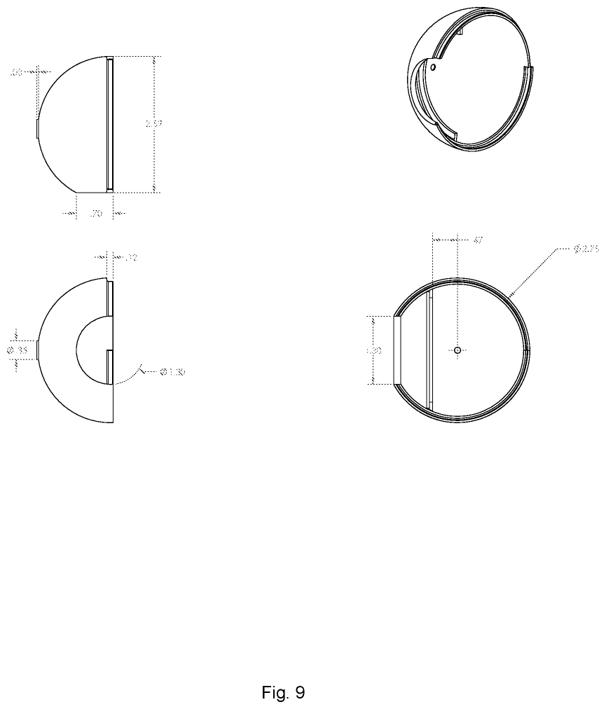

When hunting or observing wildlife in challenging or unfamiliar terrain, proper navigation aids can be helpful. In some embodiments, the trail camera comprises a global positioning system (GPS) device 13 for navigation purposes as shown in FIG. 9. The GPS device 13 can be positioned within the main body 22 and is also electronically connected to the processing unit 4. The connection to the processing unit 4 allows the GPS device 13 to be programmed to display the navigation information on the display screen 3.

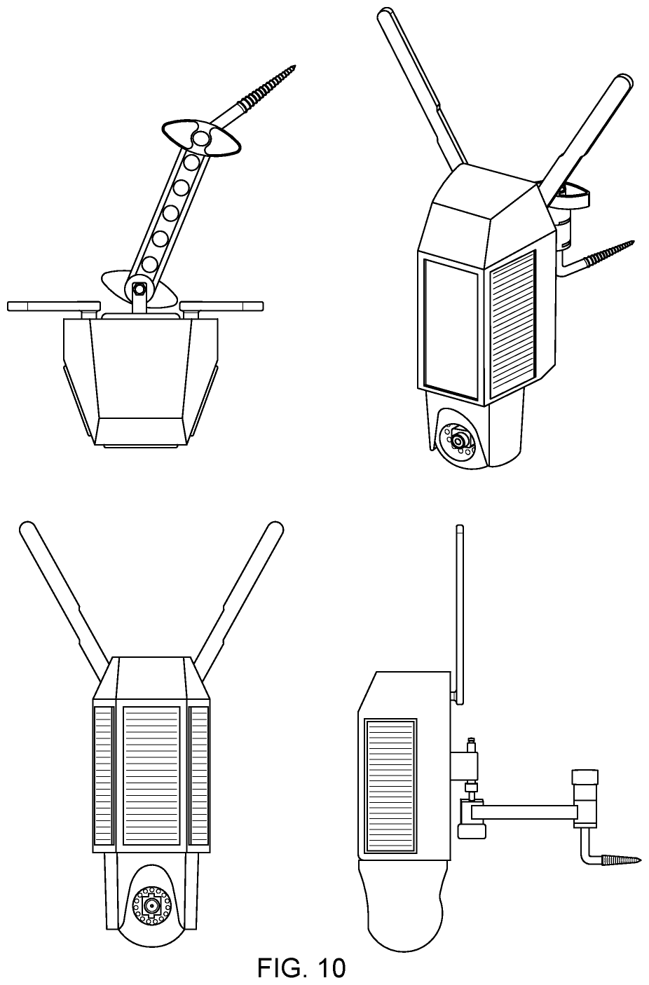

As shown in FIG. 10, in some embodiments, the trail camera further comprises a wireless data transfer unit 14 which is used to transfer data received from the primary camera 1, and/or the optional secondary camera 2, to an external storage device. In some embodiments, the wireless data transfer unit 14 comprises a 4G, 5G, or 6G cellular transceiver. In addition to transferring the data received from the primary camera 1 and/or the secondary camera 2, the wireless data transfer unit 14 can also be used to share navigation information and other related information. In order to do so, the wireless data transfer unit 14 is electronically connected to the processing unit 4, such that the transferrable data can be easily accessed via the processing unit 4. The wireless data transfer unit 14 can be positioned within the main body 22 so that the overall shape of the trail camera is not affected.

In some embodiments, the trail camera further comprises a plurality of input/output ports 18. The plurality of input/output ports 18 can be used to feed and extract data from the present invention. In order to do so, the plurality of input/output ports 18 is electronically connected to the processing unit 4 and is positioned into the main body 22. As an example, the plurality of input/output ports 18 can be used to charge a power source 20 of the present invention through a cable or transfer data through a cable. In some embodiments, the power source 20 is a solar cell or a group of solar cells. In some embodiments, the power source 20 is a solar cell, with a battery being used as a back-up source of power.

In some embodiments, the trail camera comprises a two-way radio transceiver 15 to communicate, for example, with trespassers. The two-way radio transceiver 15 is electronically connected to the processing unit 4 and is positioned within the main body 22. The two-way radio transceiver 15 can vary in different embodiments, but is configured to transmit and receive radio-frequency (RF) signals. In some embodiments, the two-way radio transceiver 15 is combined with the wireless data transfer unit 14 and implemented as a 4G, 5G, or 6G cellular transceiver. In other embodiments, the two-way radio transceiver 15 is configured for operating in the VHF and/or UHF frequency range, illustratively using one or more Family Radio Service (FRS) frequencies, one or more General Mobile Radio Service (GMRS) frequencies, one or more white-space frequencies in the VHF and/or UHF television bands, one or more Amateur Radio frequencies, and/or one or more frequencies in the VHF and/or UHF public service bands. In some embodiments, the two-way radio transceiver 15 includes an antenna or an array of antennas. In some embodiments, the antennas can be a MIMO (multiple input, multiple output) array.

In some embodiments, the two-way radio transceiver 15 includes one or more RF jacks to which one or more antennas can be connected. In some embodiments, the trail camera further comprises a microphone 16 and a speaker 17 as illustrated in FIG. 11. In particular, the microphone 16 allows the user to provide commands to one or more trespassers, and/or to one or more other trail cameras, over the two-way radio transceiver 15. Likewise, the speaker 17 allows the user to listen to information received by the two-way radio transceiver 15. The speaker 17 can also be used to output audio data from the GPS device 13. In order to execute the necessary functions, the microphone 16 and the speaker 17 are electronically connected to the processing unit 4. Moreover, the microphone 16 and the speaker 17 is also electronically connected to the two-way radio transceiver 15 such that the user can receive and send information using the two-way radio transceiver 15.

The trail camera is powered through a power source 20. The power source 20 can be, but is not limited to, a solar cell, a battery, or a combination of a solar cell and a battery. For example, in some embodiments, the solar cell charges the battery and powers the trail camera when the solar cell is illuminated, and the battery provides back-up power to the trail camera in the absence of sunlight. In order to provide power to the remainder of the components, the power source 20 is electronically connected to the processing unit 4 as in FIG. 13. For user convenience, the power source 20 can be removably attached to the main body 22 such that the power source 20 can be replaced as preferred.

In order to provide user convenience, in some embodiments, the trail camera further comprises a remote control 21 and an antenna 23 as shown in FIG. 14. The antenna 23 is electronically connected to the processing unit 4 and extends from the main body 22 allowing the remote control 21 to access the processing unit 4. In other words, the remote control 21 is wirelessly connected to the control unit 5 via the antenna 23. In some embodiments, the antenna 23 may include a MIMO (multiple input, multiple output) array. In some embodiments, the remote control 21 is a smartphone configured with an application for controlling the trail camera.

When utilizing the trail camera, for purposes of illustration, the following process flow can be followed. The primary camera 1 (FIGS. 1-6) is aimed for subsequent detection of a target object. The optional secondary camera 2 can be directed towards the user. The motion detector unit 9 detects any motion or movement in the vicinity of the trail camera and provides a notification and/or alarm to the user through the speaker 17 (FIG. 11), or via another comparable method such as a flashing light-emitting diode, or the like. If the need arises to hunt in low light conditions, the user utilizes the night vision unit 12. If a need arises to navigate through difficult terrain, the GPS device 13 can be used. Likewise, if the user needs to communicate with other users in the area, the two-way transceiver 15 can be used.

FIG. 15 is a hardware block diagram of a trail camera that is configured for pan, tilt, and zoom according to some embodiments. The trail camera includes an image sensor 101 for receiving and capturing one or more still images and/or full-motion videos. A zoom lens 102 is operatively coupled to the image sensor 101. The zoom lens 102 is operatively coupled to a zoom level adjusting and detecting circuit 103 which is arranged to detect and adjust a zoom level of the zoom lens 102. A panhead 104 is arranged to permit the image sensor 101 to be directed up and down and right and left. The panhead 104 is controlled by a panning motor driver circuit 105 and a tilting motor driver circuit 106. The panning motor driver circuit 105 is arranged to move the panhead 104 left and right. The tilting motor driver circuit 106 is arranged to move the panhead 104 up and down. A panning motor control circuit 107 controls the panning motor driver circuit 105. A tilting motor control circuit 108 controls the tilting motor driver circuit 106. The processing unit 4 controls the panning motor control circuit 107 and the tilting motor control circuit 108, thereby controlling the pan and tilt of the image sensor.

In response to the motion detector unit 9 (FIG. 7) detecting a motion of the target object, the processing unit 4 (FIGS. 7 and 15) controls the panning motor control circuit 107 (FIG. 15) and the tilting motor control circuit 108 to move the image senor left and right, and up and down, to automatically face the image sensor 101 towards the detected target object. The processing unit 4 then controls the zoom level detecting and adjusting circuit 103 to adjust the zoom level to zoom in on the detected target object. The processing unit 4 receives one or more images captured by the image sensor 101. The processing unit 4 initiates a recording of the one or more images in the memory storage device 8 (FIG. 7). The one or more images can be stored in the memory storage device 8 as one or more still images, and/or as a full-motion video. The processor 4 may provide a visual and/or audible notification/alert to the user indicating that the trail camera has detected the target object and is now in an image and/or video recording mode. The notification/alert can be provided, for example, in the form of an audible beep or tone as provided by the speaker 17 (FIG. 11).

In some embodiments, the zoom level detecting and adjusting circuit 103 (FIG. 15), the panning motor control circuit 107, and the tilting motor control circuit 103 are operatively coupled to a wireless receiver circuit. The wireless receiver circuit can be operatively coupled to one or more antennas. Adjusting one or more of the zoom level detecting and adjusting circuit 103, the panning motor control circuit 107, or the tilting motor control circuit 103, is performed in response to receiving at least one signal at the wireless receiver circuit. In some embodiments, the wireless receiver circuit is a cellular transceiver configured for communicating over a cellular network. The adjusting is performed remotely from the portable trail camera, wherein the cellular transceiver communicates with a smartphone or other mobile device over the cellular network. The smartphone or other mobile device is configured with an application for controlling the portable trail camera.

Although the invention has been explained in relation to several embodiments, it is to be understood that many other possible modifications and variations can be made without departing from the spirit and scope of the invention as hereinafter claimed.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

The diagrams depicted herein are separate examples but may be the same or different embodiments. Any of the operations in one diagram could be adopted and shared with another diagram. No example operation is intended to limit the subject matter of any embodiment or corresponding claim.

It is important to note that all the diagrams and corresponding processes derived from them, may be part of a same process or may share sub-processes with one another, thus making the diagrams combinable into a single preferred embodiment that does not require any one specific operation but which performs certain operations from one example process and from one or more additional processes. All the example processes are related to the same physical system and can be used separately or interchangeably.

Although an exemplary embodiment of at least one of a device, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A portable trail camera comprising:
an image sensor;
a zoom lens, operatively coupled to the image sensor, for applying a zoom level to one or more images captured by the image sensor;
a zoom level detecting and adjusting circuit, operatively coupled to the zoom lens, for detecting and adjusting the applied zoom level;
a panhead, operatively coupled to the image sensor, that permits the image sensor to be adjusted azimuthally in a left-right direction, and adjusted elevationally in an upward-downward direction;
a panning control circuit, operatively coupled to the panhead, for controlling a motion of the panhead azimuthally in the left-right direction;
a tilting control circuit, operatively coupled to the panhead, for controlling a motion of the panhead elevationally in the upward-downward direction;
an object detection circuit, operatively coupled to the image sensor, for detecting a motion of a target object;
a processing unit, operatively coupled to the image sensor, the zoom level detecting and adjusting circuit, the panning control circuit, the tilting control circuit, and the object detection circuit; and
a memory storage device operatively coupled to the processing unit.

2. The portable trail camera of claim 1 wherein, in response to the object detection circuit detecting the motion of the target object, the processing unit controls the panning control circuit and the tilting control circuit to aim the image sensor towards the target object.

3. The portable trail camera of claim 2 wherein, in response to controlling the panning control circuit and the tilting control circuit, the processing unit controls the zoom level detecting and adjusting circuit to automatically focus the image sensor on the target object.

4. The portable trail camera of claim 3, wherein the image sensor captures one or more images of the target object; and wherein the processing unit stores the one or more captured images in the memory storage device.

5. The portable trail camera of claim 1, further comprising a wireless receiver circuit operatively coupled to the zoom level detecting and adjusting circuit, the panning control circuit, and the tilting control circuit.

6. The portable trail camera of claim 5, wherein the wireless receiver circuit is operatively coupled to one or more antennas.

7. The portable trail camera of claim 5, wherein an adjustment of one or more of: the zoom level detecting and adjusting circuit, the panning control circuit, or the tilting control circuit; is performed in response to receiving at least one signal at the wireless receiver circuit.

8. The portable trail camera of claim 7, wherein the wireless receiver circuit is a cellular transceiver configured for communicating over a cellular network.

9. The portable trail camera of claim 8, wherein the adjustment is performed remotely from the portable trail camera, such that the cellular transceiver communicates with a smartphone or other mobile device over the cellular network, and the smartphone or other mobile device is located remotely with respect to the portable trail camera.

10. The portable trail camera of claim 9, wherein the smartphone or other mobile device is configured with an application for controlling the portable trail camera.

11. The portable trail camera of claim 1, further comprising a speaker configured to provide an audible notification and/or an audible alert to a user in response to one or more of:
the object detection circuit detecting the motion of the target object;
the image sensor capturing one or more images of the target object; and/or
the processing unit storing the one or more captured images in the memory storage device.

12. The portable trail camera of claim 1, further comprising a cellular transceiver, operatively coupled to the processing unit, for uploading the one or more captured images from the memory storage device and transmitting the one or more captured images over a cellular communications network.

13. The portable trail camera of claim 12, further comprising a multiple input, multiple output (MIMO) antenna array operatively coupled to the cellular transceiver.

14. The portable trail camera of claim 1, further comprising a radio frequency transceiver operatively coupled to a microphone and a speaker, the radio frequency transceiver configured for performing two-way communication over a radio frequency communications link.

15. The portable trail camera of claim 14, further comprising a multiple input, multiple output (MIMO) antenna array operatively coupled to the radio frequency transceiver.

16. The portable trail camera of claim 1, wherein the image sensor further comprises an infrared night vision sensor configured for viewing the target object under low-light conditions.

17. The portable trail camera of claim 1, further comprising a solar cell operatively coupled to a backup battery, wherein the solar cell powers the portable trail camera when the solar cell is illuminated, wherein the backup battery powers the portable trail camera when the solar cell is not illuminated, and wherein the solar cell charges the backup battery when the solar cell is illuminated.

18. The portable trail camera of claim 1, further comprising a main body and a secondary camera, wherein the image sensor is positioned opposite the secondary camera across the main body, and wherein the secondary camera is operatively coupled to the processing unit.

19. The portable trail camera of claim 1, further comprising a global positioning system (GPS) device, operatively coupled to the processing unit.

20. The portable trail camera of claim 19, wherein the one or more images of the target object are associated with a geographic location obtained by the GPS device, and the one or more images are stored with the geographic location in the memory storage device.
